(19) United States
(12) Patent Application Publication
(10) Pub. No.: US 2011/0218677 A1
(43) Pub. Date: Sep. 8, 2011

(54) MEDICAL MANIPULATOR SYSTEM

(75) Inventors: Makoto JINNO, Fujinomiya-shi (JP); Ryohei Katsuki, Fujinomiya-shi (JP)

(73) Assignee: TERUMO KABUSHIKI KAISHA, Shibuya-ku (JP)

(21) Appl. No.: 13/037,677

(22) Filed: Mar. 1, 2011

(30) Foreign Application Priority Data
Mar. 3, 2010 (JP) 2010-046720

(51) Int. Cl. B25J 13/00

(52) U.S. Cl. 700/264; 901/31

(57) ABSTRACT

A medical manipulator system includes a manipulator including a working unit having a distal end at which an end effector for carrying out working is provided and an operating unit including an operating input unit for being operated for an input and a driving source for operating in response to contents of an operation of the operating input unit to drive the end effector, the working unit being removably attached to the operating unit. A controller to which the operating unit can be connected controls at least the driving source. A use history retaining unit is adapted to retain use history data for each working unit.

### CROSS REFERENCE TO RELATED APPLICATIONS

This document claims priority to Japanese Application Number 2010-046720, filed Mar. 3, 2010, the entire content of which are hereby incorporated by reference.

### BACKGROUND OF THE INVENTION

1. Field of the Invention

This invention relates to a medical manipulator system including an operating unit, and a working unit removably attached to the operating unit and having an end effecter such as a gripper at a distal end of a shaft thereof.

2. Description of the Related Art

In endoscopic surgery (also called laparoscopic surgery), a plurality of holes are perforated in the abdominal part or the like of a patient, and trocars (tubular instruments) are inserted into the holes. Thereafter, a laparoscope (camera) and a plurality of forceps are inserted into a body cavity through the trocars. A gripper for gripping biotissue, scissors, a blade of an electrode knife or the like is attached to a distal end portion of each forceps. After the laparoscope and a forceps are inserted into a body cavity, the forceps is operated to carry out surgery while the operator observes the internal situation of the body cavity which is displayed on a monitor connected to the laparoscope. Since such a surgical method as just described does not require abdominal sectioning, the burden on the patient is light and the number of days before recovery or discharge from the hospital after the surgery are reduced significantly. Therefore, it is expected that such a surgical method as described above can be applied to an expanded field.

Development of a forceps called a medical manipulator which has a plurality of joints at a distal end portion thereof to change the posture of the distal end portion as a forceps to be inserted through a trocar is being carried out in addition to common forceps which have no joint at a distal end portion thereof (refer to Japanese Patent Laid-Open No. 2008-104855, also published as US Publication No. 2008/0262654 A1. The entire contents of US Publication No. 2008/0262654 A1 is hereby incorporated by reference. Such a medical manipulator as just described can carry out motion with a high degree of freedom in a body cavity, facilitates manipulation and increases applicable cases.

The medical manipulator proposed in US Publication No. 2008/0262654 A1 includes a working unit including a distal-end working unit having an end effector and a joint, and an operating unit having a driving source for driving the distal end moving unit to move. The working unit is removably attached to the operating unit, and in a state in which the working unit is attached to the operating unit, driving power of the driving source is transmitted to the distal end moving unit to move the distal end moving unit.

Incidentally, the working unit described above includes, for example, a wire as a power transmission member. This wire suffers from deterioration such as elongation as use thereof proceeds, resulting in the possibility that operation of the distal end moving unit may be rather disturbed.

### SUMMARY OF THE INVENTION

It is an object of the present invention to provide a medical manipulator system wherein a working unit is compulsorily disabled from use when the number of times of actual use thereof reaches a preset number.

According to the present invention, there is provided a medical manipulator system including a manipulator including a working unit having a distal end at which an end effector that carries out an assigned work is provided, and an operating unit including a driving source for operating in response to an operation of an operating input unit, to drive the end effector, the working unit being removably attached to the operating unit. The medical manipulator system also includes a controller to which the operating unit can be connected and which controls at least the driving source, and a use history retaining unit adapted to retain use history data for each working unit. The working unit includes an ID retaining unit for retaining unique identification information of the working unit. The operating unit includes an ID detection unit that detects the unique identification information retained by the ID retaining unit. The controller refers to the use history data of the working unit attached to the operating unit and determines an instruction from the operation input unit to be an invalid instruction if the number of times of actual use of the working unit exceeds a preset number of times.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a perspective view of a medical manipulator system according to an embodiment of the present invention;

FIG. 2 is a schematic side elevational view, partly in section, showing a manipulator in a state in which an operating unit and a working unit are separate from each other;

FIG. 3 is a partial perspective view showing a composite input unit and peripheral elements;

FIGS. 4 to 7 are schematic side elevational views illustrating a general configuration of medical manipulator systems according to first to fourth configuration examples, respectively;

FIG. 8 is a diagrammatic view illustrating a time rule;

FIG. 9 is a schematic perspective view showing a medical robot system; and

FIG. 10 is a flowchart showing the steps performed by the controller to determine whether the operation by the operator of the input unit is invalid.

### DETAILED DESCRIPTION OF THE PREFERRED EMBODIMENT

Referring now to the drawings wherein like reference numerals designate identical or corresponding parts through the several views, a preferred embodiment of a medical manipulator system (hereinafter referred to simply as manipulator system) according to the present invention is described in detail.

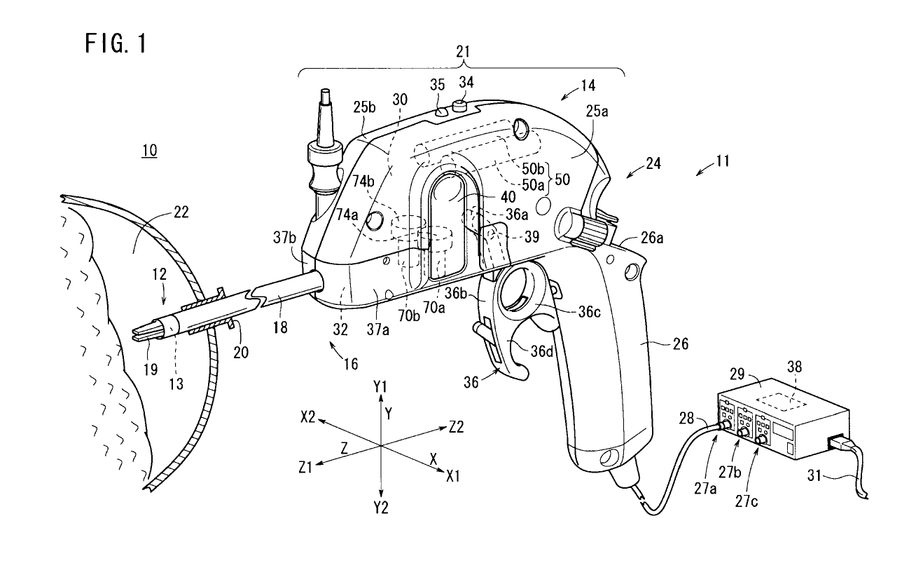

Referring first to FIG. 1, there is shown a general configuration of a manipulator system 10 according to an embodiment of the present invention. The manipulator system 10 includes a manipulator 11 which is a medical apparatus that grasps a part of a living body or touching with the living body by means of a distal-end working unit 12 provided at a distal end thereof to carry out a predetermined treatment. The manipulator system 10 further includes a controller 29 connected to the manipulator 11 through a cable 28. The manipulator 11 includes a body 21, a shaft 18 extending from the body 21, and the distal-end working unit 12 provided at the distal end of the shaft 18.

In the following description, the extending direction of the shaft 18 is defined as Z direction, and the forward direction, that is, a direction toward the distal end of the shaft 18, is defined as Z1 direction while the rearward direction, that is, a direction toward the proximal end of the shaft 18, is defined as Z2 direction. Further, a direction which is perpendicular to the Z direction and is a leftward or rightward direction with reference to the manipulator 11 is defined as X direction when the manipulator 11 has a posture illustrated in FIG. 1. Particularly, the leftward direction with respect to the manipulator 11 is defined as X1 direction and the rightward direction with respect to the manipulator 11 is defined as X2 direction. Further, a direction which is perpendicular to the Z direction and is an upward or downward direction of the manipulator 11 is defined as Y direction when the manipulator 11 assumes the posture illustrated in FIG. 1. Particularly, the upward direction is defined as the Y1 direction and the downward direction is defined as the Y2 direction.

It is to be noted that, unless otherwise specified, the directions mentioned above are represented with reference to a standard posture or neutral posture of the manipulator 11. The directions are used for the convenience of description, and it is a matter of course that the manipulator 11 can be used in an arbitrary direction, for example, in an upwardly and downwardly reversed posture.

The manipulator 11 has an operating unit 14 to be grasped and operated by a hand of a person, and a working unit 16 removably attached to the operating unit 14. The operating unit 14 is a part of the body 21 described above and includes a pair of left and right upper covers 25a and 25b extending in Z1 direction and Y2 direction so as to form a housing of a substantially L shape. The operating unit 14 further includes a driving unit 30 accommodated in a space between the upper covers 25a and 25b, and a composite input unit 24 serving as an operation input unit to be operated by a hand of an operator.

The driving unit 30 includes two motors 50a and 50b as a driving source 50 that changes the posture of the distal-end working unit 12 such that driving force of the driving source 50 can be mechanically transmitted to the distal-end working unit 12 to change the posture of an end effector 19.

In the proximity of a top portion of the operating unit 14 in the Y1 direction, a master switch 34 is provided such that it is exposed from the upper covers 25a and 25b, and an LED 35 is provided at a place at which it can be visually observed readily in the Z1 direction in the proximity of the master switch 34.

A portion of the operating unit 14 extending in the Y2 direction at the proximal end thereof forms a grip handle 26 to be grasped by a hand of an operator. The composite input unit 24 is provided on an inclined face of an upper portion of the grip handle 26. When a turning operation in the leftward or rightward direction and/or a tilting operation are carried out independently or compositely, a signal corresponding to the operation is transmitted to the controller 29. The controller 29 thus controls driving of the driving unit 30 to carry out a posture change of the end effector 19.

The working unit 16 includes a housing formed of a pair of lower covers 37a and 37b disposed substantially symmetrically in the Z direction. The working unit 16 further includes the distal-end working unit 12 described hereinabove, an elongated hollow shaft 18 provided at the distal end of the distal-end working unit 12, and a pulley box 32 to which the proximal portion of the shaft 18 is secured and which is accommodated in a space between the lower covers 37a and 37b. The working unit 16 further includes a trigger lever 36 provided rearwardly of the pulley box 32 and pivotally supported around an axis in the X direction with a trigger shaft 39 being the pivotal center. The lower covers 37a and 37b, pulley box 32 and trigger lever 36 form a part of the body 21 described hereinabove.

The working unit 16 is removably connected and secured to the operating unit 14 by means of a pair of left and right attaching levers 40 provided on the operating unit 14 such that it can be separated from the operating unit 14 by an opening operation of the attaching levers 40. Thus, an exchange of the operation unit 14 can be carried out readily at a site of a surgical operation without using a special device.

The distal-end working unit 12 includes an end effector 19 that makes opening and closing movements in response to an operation of the trigger lever 36, and a posture changing mechanism 13 that changes the posture of the end effector 19 in response to an operation of the composite input unit 24. The end effector 19 makes opening and closing movements with reference to a predetermined axis, for example, as a gripper for gripping a part of a living body or a needle for suture, scissors for cutting a part of the living body, or a like element of other types.

The distal-end working unit 12 and the shaft 18 are small in diameter such that they can be inserted into a body cavity 22 through a trocar 20 of a cylindrical shape mounted at the abdominal region or the like of a patient. Thus, various techniques such as excision, grasping, suture, ligation and so forth of an affected part can be carried out in the body cavity 22 by operation of the composite input unit 24 and the trigger lever 36.

The trigger lever 36 includes an arm portion 36a pivotally supported on the trigger shaft 39 that is provided at a proximal end portion (the Z2 direction) in the space between lower covers 37a and 37b, and a trigger operating element 36b provided on the Y2 direction side of the arm portion 36a. The trigger operating element 36b has a finger ring 36c, and a finger keeper 36d of a substantially arcuate shape provided on the Y2 direction side of the finger ring 36c.

The opening or closing movement of the end effector 19 is carried out through mechanical transmission thereto of force based on an operation, that is, a pushing or pulling operation, of the trigger lever 36 by a hand of the operator. In particular, a transmission mechanism includes a rod, a wire serving as a power transmitting member, a pulley and so forth in the inside of the working unit 16. A pushing or pulling operation of the trigger lever 36 is converted into an opening or closing movement of the end effector 19 by the transmission mechanism.

The posture changing mechanism 13 can make a roll movement of the end effector 19 around a roll axis, which is the Z axis in the neutral posture of the manipulator, and a yaw movement or tilt movement of the end effector 19 with reference to a yaw axis of the Y direction. The posture changing mechanism 13 can selectively or compositely make the roll movement and the tilt movement. Accordingly, the distal-end working unit 12 can make three-axis movements including the opening and closing movement, roll movement and yaw movement of the end effector 19.

In the present embodiment, the posture changing movement of the end effector 19 including the roll movement and the yaw movement is carried out by mechanical transmission of driving force of the driving source 50 to the distal-end working unit 12 when the driving source 50 is controlled in response to a manipulation of the composite input unit 24.

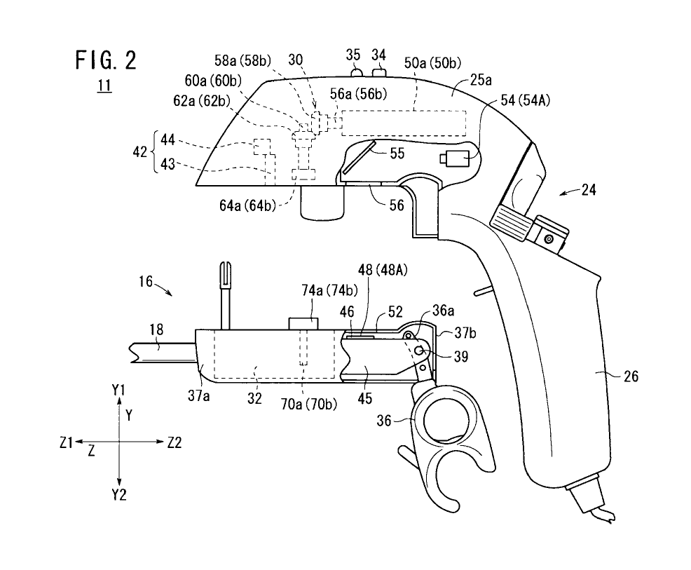

As shown in FIG. 2, the driving unit 30 includes the motors 50a and 50b described hereinabove, two driving bevel gears 58a and 58b secured to output power shafts 56a and 56b of the motors 50a and 50b, respectively, two driven bevel gears 62a and 62b held in meshing engagement with the driving bevel gears 58a and 58b, respectively, and two drive shafts 60a and 60b to which the driven bevel gears 62a and 62b are secured, respectively. Engaging projections 64a and 64b having a cross section of, for example, a wavy shape are provided at a bottom portion of the drive shafts 60a and 60b, respectively. By the configuration described, rotational driving force of the motor 50a (50b) is transmitted successively to the driving bevel gear 58a (58b), driven bevel gear 62a (62b), drive shaft 60a (60b) and engaging projection 64a (64b).

Pulleys 70a and 70b are provided in the pulley box 32. The pulleys 70a and 70b are coaxial with the drive shafts 60a and 60b, respectively, when the working unit 16 is attached on the operating unit 14. At an upper end of the pulleys 70a and 70b, engaging recesses 74a and 74b of a cross section, for example, of a matching wavy shape are provided in such a manner as to be exposed from the upper face of the pulley box 32. Accordingly, upon attachment of the working unit 16 to the operating unit 14, the engaging projections 64a and 64b and the engaging recesses 74a and 74b are engaged with each other, respectively. Consequently, rotational driving force from the drive shafts 60a and 60b are transmitted to the pulleys 70a and 70b, respectively. It is to be noted that the engaging structure of the engaging projection 64a or the engaging recess 74a may have a different structure.

A wire (not shown) as a power transmission member is wrapped around each of the pulleys 70a and 70b. The wires are fitted in the shaft 18 and transmit driving power to the posture changing mechanism 13 provided in the distal-end working unit 12 as shown in FIG. 1. Consequently, rotational driving force from the drive shafts 60a and 60b is transmitted to the posture changing mechanism 13 through the pulleys 70a and 70b and the wires to carry out posture change of the end effector 19.

It is to be noted that a mechanism that converts an operation of the trigger lever 36 into an opening or closing movement of the end effector 19 and a mechanism that converts driving of the driving source 50 into a posture changing movement of the end effector 19, similar to those disclosed, for example, in Japanese Patent Laid-Open No. 2008-104855 and Japanese Patent Laid-Open No. 2009-106606 may be adopted. The entire contents of these two references are hereby incorporated by reference.

The operating unit 14 includes a attachment detection mechanism 42 for detecting attachment and detachment of the working unit 16 on and from the operating unit 14. The attachment detection mechanism 42 includes a detection shaft 43 which functions as a sensor dog, and a detection unit 44 for detecting an end portion, particularly an upper end portion, of the detection shaft 43. The detection shaft 43 is movably supported in the Y direction in the operating unit 14 and is normally biased resiliently in the Y2 direction, that is, in the downward direction in FIG. 2, by a coil spring (not shown). Further, the detection shaft 43 is prevented from coming off by a snap ring (not shown).

The detection unit 44 can be made, for example, of a photo-sensor including a light emitting element and a light receiving element disposed facing each other. Such a photo-sensor as just described can detect the presence of the detection shaft 43 when the detection shaft 43 advances into a light path between the light emitting element and the light receiving element to intercept the light path. Since the attachment detection mechanism 42 is configured in such a manner as described above, when the working unit 16 is attached to the operating unit 14, the detection shaft 43 is pushed to move in the Y1 direction by the working unit 16, whereupon an upper end of the detection shaft 43 is detected by the detection unit 44. The controller 29 recognizes, based on a signal from the detection unit 44, that the working unit 16 is attached to the operating unit 14.

At a position between the pulley box 32 and the arm portion 36a, an ID indicating plate 46 extends between and is secured to a pair of support plates 45 which support the opposite ends of the trigger shaft 39. A barcode 48A that indicates an image pattern corresponding to the contents of various kinds of information regarding the working unit 16 is provided on the surface of the ID indicating plate 46 as an ID retaining unit 48 that retains the various kinds of information regarding the working unit 16. The barcode 48A is exposed upwardly of the working unit 16 through a cutaway portion 52 formed in a top wall of the lower cover.

The barcode 48A may be a printed one-dimensional barcode including white or blank and dark or black lines having different widths and arrayed alternately or a printed matrix type two-dimensional barcode such as a printed QR code including white or blank portions and dark or black portions in accordance with squares. The barcode 48A includes unique identification information (ID) of the working unit 16 and information regarding the specifications, timestamp (fabrication date and so forth), serial number, the number of times of actual use, the limit number of times of actual use and so forth. The unique identification information retained by the barcode 48A has a unique value so that each working unit 16 can be identified from any other working unit 16.

A camera 54A that picks up an image of the barcode 48A is disposed as a ID detection unit 54 that detects the barcode 48A in the inside of the operating unit 14. Further, an image pickup window 56 formed of a transparent member is provided at a position of the operating unit 14 that corresponds to the position of the barcode 48A when the working unit 16 is attached to the operating unit 14. Furthermore, a mirror 55 reflects light or an image of the barcode 48A toward the camera 54A through the image pickup window 56. Therefore, an image of the barcode 48A is picked up as a mirror image by the camera 54A. It is to be noted that an LED (not shown) is provided in the proximity of the camera 54A so that the barcode 48A is illuminated by the LED. A plurality of such LEDs may be provided so that a sufficient amount of light may be obtained.

Since such a barcode 48A as described above is provided on the working unit 16, the operating unit 14 and the controller 29 can recognize the unique identification information of the working unit 16 using the camera 54A and drive and control the motors 50a and 50b and so forth appropriately and accurately in response to the type of the working unit 16 such as, for example, a gripper, scissors or an electric cautery.

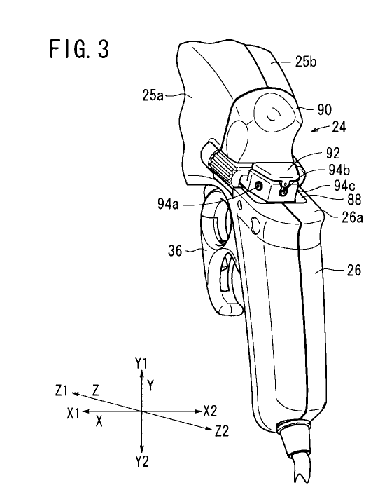

Referring now to FIG. 3, the composite input unit 24 that electrically drives the distal-end working unit 12 has a structure symmetrical in the X1 and X2 directions with respect to the Z axis or Y axis. The composite input unit 24 gives turning instructions to the distal-end working unit 12 regarding the rolling direction (rotating direction) around the axis and the yaw direction (leftward and rightward directions).

The composite input unit 24 is supported by a sensor holder 88 disposed on an inclined face 26a and includes a rotational operating unit 90 on the Z1 direction side or Y1 direction side of the inclined face 26a, a tilting operating unit 92 provided on the Z2 direction side or Y2 direction side of the inclined face 26a, and three switch operators 94a to 94c disposed on a side face of a lower portion of the tilting operating unit 92. When an inputting operation for the rotational operating unit 90 or tilting operating unit 92 is carried out, the operation amount is detected by a switch board (not shown) or the like provided in the sensor holder 88, and the motors 50a and 50b are suitably controlled and driven in response to the detected operation amount under the control of the controller 29.

Referring back to FIG. 1, the controller 29 is connected to a cable 28 extending from a lower end portion of the grip handle 26. The controller 29 is a control unit that totally controls the manipulator 11. It is also possible to incorporate some or all of the functions of the controller 29, for example, integrally in the operating unit 14. Power is supplied to the controller 29 from an external power supply, that is, an AC power supply, through the power supply cable 31. The power supply cable 31 is removably connected to the controller 29. The controller 29 has, for example, a first port 27a, a second port 27b and a third port 27c such that three manipulators 11 can be controlled simultaneously and independently of each other.

The controller 29 can use detection by the attachment detection mechanism 42 of attachment of the working unit 16 as a trigger signal for controlling the camera 54A and the LED to start to acquire the unique identification information from the barcode 48A. In particular, substantially simultaneously with attachment of the working unit 16 on the operating unit 14, the controller 29 controls and drives the camera 54A and the LED to acquire the unique identification information from the barcode 48A. Only when the working unit 16 is attached to the operating unit 14 does the controller 29 control and drive the camera 54A and the LED to acquire the unique identification information from the barcode 48A. At any other time, the controller 29 controls the camera 54A and the LED to stop their operation so that the processing load can be reduced and a reduction in power consumption can be achieved.

A use history retaining unit 38 that retains use history data for each working unit 16 is provided in the controller 29. The use history retaining unit 38 is a nonvolatile storage medium and stores the number of times of actual use, sterilization date time and so forth as use history data of each working unit 16. Further, the controller 29 has a function of counting the number of times of actual use of the working unit 16. Details of the counting method of the number of times of actual use will be later described.

Now, as a system configuration which can suitably carry out collection, updating and storage of use history data of the working unit 16 described hereinabove, several examples of the configuration of the manipulator system 10 are described.

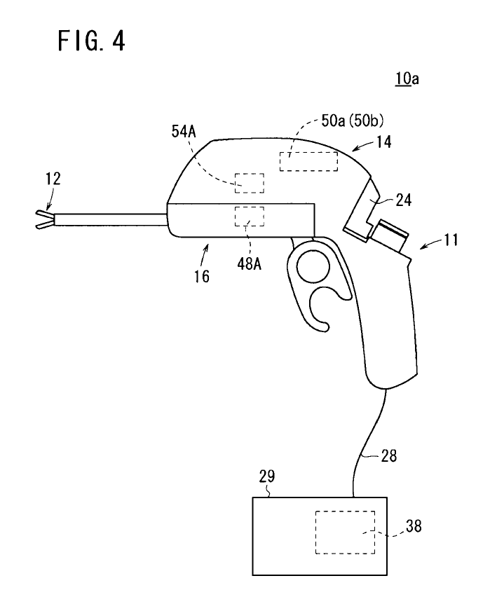

FIG. 4 is a schematic view showing a general configuration of a manipulator system 10a according to a first configuration example. Referring to FIG. 4, the manipulator system 10a includes a manipulator 11 and a controller 29 connected to the manipulator 11 through a cable 28, and is suitable for use in the case where a single controller 29 is installed in one medical facility. The manipulator 11 and the controller 29 are similar to the manipulator 11 and the controller 29 described hereinabove with reference to FIGS. 1 to 3, respectively.

In the manipulator system 10a in an operating condition with power being supplied thereto, when the operating unit 14 is connected to the controller 29 and the working unit 16 is attached to the operating unit 14, the controller 29 recognizes the attachment of the working unit 16 and issues to the camera 54A a control instruction for acquiring the unique identification information of the attached working unit 16. Consequently, the camera 54A acquires and analyzes the unique identification information of the working unit 16 from the barcode 48A and sends a result of the analysis to the controller 29.

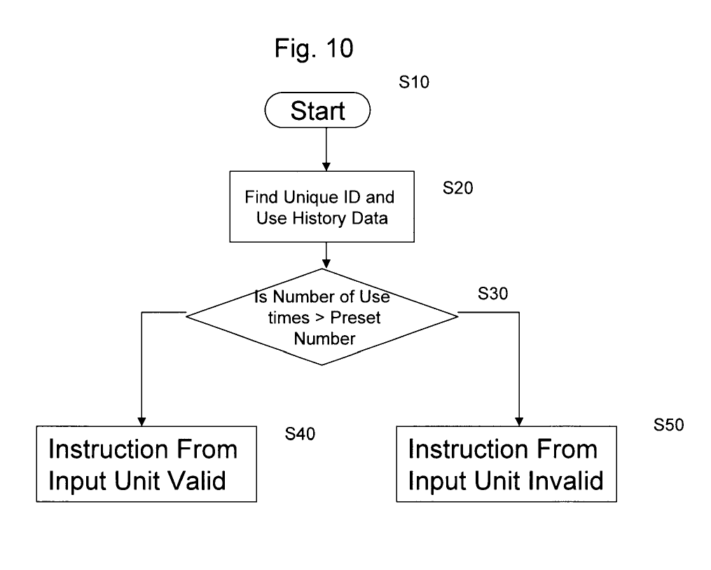

The controller 29 may be a computer programmed to perform the steps of FIG. 10. The controller 29 refers to the unique identification information of the working unit 16 and use history data stored in a storage unit (step S20), that is, the use history retaining unit 38 in the controller 29, and determines whether or not the working unit 16 is still usable. In particular, it compares the number of times of actual use of the working unit 16 to its use limit time number (step S30). If the number of times of actual use of the working unit 16 is within its use limit time number, the controller 29 decides that the working unit 16 is usable (step S40), but if the number of times of actual use of the working unit 16 exceeds the use limit time number, the controller 29 decides that the working unit 16 is not usable any longer (step S50).

If the controller 29 decides that the working unit 16 is usable, it counts up the number of times of actual use and updates the use history data. If the composite input unit 24 of the manipulator 11 is operated and the working unit 16 attached thereto is determined to be usable, the controller 29 controls driving of the motors 50a and 50b in response to the operation of the composite input unit 24 so that the distal-end working unit 12 operates. It is to be noted that, when the controller 29 carries out counting of the number of times of actual use of the working unit 16, it may apply a time rule which will be explained later.

On the other hand, if the controller 29 decides that the working unit 16 is unusable, it determines that an instruction from the composite input unit 24 is an invalid instruction. Therefore, even if an operator operates the composite input unit 24, the motors 50a and 50b are not driven, and the distal-end working unit 12 does not work.

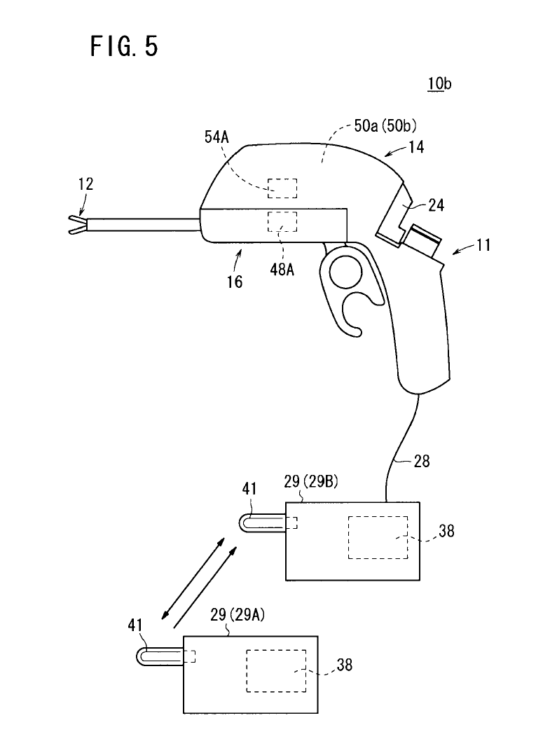

FIG. 5 shows a general configuration of a manipulator system 10b according to a second configuration example. Referring to FIG. 5, the manipulator system 10b includes at least one manipulator 11 and a plurality of, two in the example shown, controllers 29 which can be connected to the manipulator 11 through respective cables 28, and is suitable for use where a plurality of controllers 29 are provided in one medical facility.

The manipulator 11 is similar to the manipulator 11 described hereinabove with reference to FIGS. 1 to 3. The controllers 29 have a configuration basically similar to that of the controller 29 described hereinabove with reference to FIG. 1. However, one of the controllers 29, such as a controller 29A, is set as a master controller which carries out collection, updating and storage of use history data of a newly attached working unit 16 while the remaining one or ones, such as a controller 29B, is set as a slave controller. It is to be noted that the controllers 29 are configured such that the master controller and the slave controller or controllers can be changed over by changing over of the settings. In the following description, the controller 29A is referred to as the master controller and the controller 29B is referred to as the slave controller for the convenience of description.

A memory key 41 (removable memory) for retaining use history data of each working unit 16 can be connected to the master controller 29A and the slave controller 29B. The memory key 41 is a nonvolatile memory and may have a form of, for example, a USB memory.

In order for the slave controller 299 to use the manipulator 11 in the present manipulator system 10b, the memory key 41 is connected to the master controller 29A first. Then, the master controller 29A copies the use history data into a storage unit provided therein, that is, into the use history retaining unit 38.

Then, the memory key 41 is removed from the master controller 29A and then connected to the slave controller 29B. Thereafter, a working unit 16 is attached to the operating unit 14 connected to the slave controller 29B. Thus, the slave controller 29B recognizes the attachment of the working unit 16 and issues to the camera 54A a control instruction for acquiring the unique identification information. Consequently, the camera 54A picks up an image of the barcode 48A to acquire and analyze the unique identification information of the working unit 16, and sends a result of the analysis to the slave controller 29B.

The slave controller 29B refers to the unique identification information of the working unit 16 and the use history data stored in the memory key 41 and determines whether or not the working unit 16 is still usable. It is to be noted that, if the number of times of actual use of the working unit 16 is within its use limit time number, the slave controller 298 decides that the working unit 16 is usable, but if the number of times of actual use of the working unit 16 exceeds the use limit time number, the slave controller 29B decides that the working unit 16 is not usable any longer.

If the slave controller 29B decides that the working unit 16 is usable, it counts up the number of times of actual use and updates the use history data stored in the memory key 41. If the composite input unit 24 of the manipulator 11 is operated and the working unit 16 attached thereto is determined to be usable, the slave controller 29B controls driving of the motors 50a and 50b in response to the operation of the composite input unit 24 so that the distal-end working unit 12 operates. It is to be noted that, when the slave controller 29B carries out counting of the number of times of actual use of the working unit 16, a time rule may be applied which rule will be explained later.

On the other hand, if the slave controller 29B decides that the working unit 16 is unusable, it determines that an instruction from the composite input unit 24 is an invalid instruction. Therefore, even if an operator operates the composite input unit 24, the motors 50a and 50b are not driven and the distal-end working unit 12 does not operate.

In this manner, with the manipulator system 10b according to the second configuration example, since use history data are collected into and updated in the master controller 29A through the memory key 41, the latest use history data is stored into the master controller 29A. On the other hand, in order for the slave controller 29B to be used with the working unit 16, it is necessary to connect the memory key 41 to the slave controller 29B, in which memory key the use history data copied from the master controller 29A are stored. Therefore, the slave controller 29B uses the latest use history data which the master controller 29A has. Consequently, also in the case where a plurality of controllers 29 are provided in one medical facility, collection, updating and storage of the number of times of actual use can be carried out with certainty and the number of times of actual use can be counted appropriately.

After a use case (one surgical operation) comes to an end, the use history of the used working unit 16 is updated and recorded in the memory key 41. Accordingly, when the memory key 41 is connected to the master controller 29A or when the data of the memory key 41 is to be updated, the use history data in the master controller 29A and the use history data of the memory key 41 are compared with each other. Then, if the use history data of the memory key 41 is more recent than the data of the number of times of actual use of the working unit 16 stored in the master controller, the use history data of the master controller 29A is updated based on the data stored in the memory key 41. By the updating, the use history data of the master controller 29A can be appropriately made the latest data.

It is necessary for the slave controller 29B to refer to the use history data of the attached working unit 16 and carry out updating as occasion demands, every time a working unit 16 is attached to the operating unit 14 connected to the slave controller 29B. Further, since the use history data of the working unit 16 is preferably recorded immediately into the memory key 41, if the memory key 41 is not connected to any controller 29, it is preferable to disable use of the working unit 16 even if the operating unit 14 is connected to the slave controller 29B and the working unit 16 is attached.

If a plurality of memory keys 41 are available, a term of validity (expiration date) is preferably set to the use history data stored in the memory keys 41. In particular, if the use history data is copied from the master controller 29A into the memory key 41 and then the memory key 41 is connected to the slave controller 29B after lapse of the term of validity, the slave controller 29B should determine the use history data as invalid data and determine an instruction from the composite input unit 24 as an invalid instruction. The term of validity may be, for example, three hours, six hours, 12 hours, 24 hours or a period of time for one use case (surgical operation). By setting a term of validity for the use history data stored in each memory key 41 in this manner, even if a plurality of such memory keys 41 are available, the error of the number of times of actual use can be reduced.

It is to be noted that, in the manipulator system 10b, the manipulator 11 may be connected to and used together with the master controller 29A rather than the slave controller 29B. The method of use in this instance is similar to that of the manipulator system 10a according to the first configuration example.

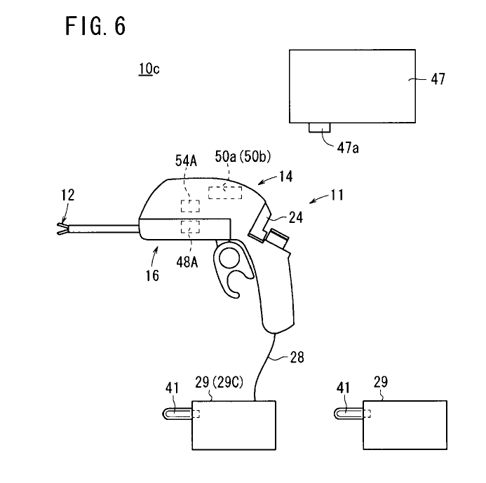

FIG. 6 shows a general configuration of a manipulator system 10c according to a third configuration example. Referring to FIG. 6, the manipulator system 10c includes use history management means 47 in place of the master controller 29A in the manipulator system 10b according to the second configuration example is replaced by. In particular, the manipulator system 10c includes at least one manipulator 11, a plurality of, two in the example shown, controllers 29 which can be connected to the manipulator 11 through respective cables 28, and use history management means 47 for carrying out collection, updating and storage of use history data of the working unit 16. The manipulator system 10c is suitable for use where a plurality of controllers 29 are provided in one medical facility.

The manipulator 11 is similar to the manipulator 11 described hereinabove with reference to FIGS. 1 to 3. While the two controllers 29 are similar to the controller 29 described hereinabove with reference to FIG. 1, a memory key 41 for retaining use history data of each working unit 16 can be connected to the two controllers 29. The use history management unit 47 includes a connecting port 47a to which the memory key 41 can be connected. Such use history management unit 47 may be, for example, a programmed general purpose computer.

In the manipulator system 10c, in order to use one of the controllers 29, which is hereinafter referred to as controller 29C, to use the manipulator 11, the memory key 41 is connected to the use history management unit 47. Consequently, the use history management unit 47 copies use history data into the memory key 41.

Then, the memory key 41 is removed from the use history management unit 47 and then connected to the controller 29C. Thereafter, a working unit 16 is attached to the operating unit 14 connected to the controller 29C. Thus, the controller 29C recognizes the attachment of the working unit 16 and issues to the camera 54A a control instruction to acquire unique identification information. Consequently, the camera 54A picks up an image of the barcode 48A to acquire and analyze the unique identification information of the working unit 16 and sends a result of the analysis to the controller 29C.

The controller 29C refers to the unique identification information of the working unit 16 and the use history data stored in the memory key 41 and determines whether or not the working unit 16 is still usable. Then, if the number of times of actual use of the working unit 16 is within its use limit times number, the controller 29C decides that the working unit 16 is usable, but if the number of times of actual use of the working unit 16 exceeds the use limit times number, the controller 29C decides that the working unit 16 is not usable any longer.

If the controller 29C decides that the working unit 16 is usable, it counts up the number of times of actual use and updates the use history data stored in the memory key 41. If the composite input unit 24 of the manipulator 11 is operated and the working unit 16 attached thereto is determined to be usable, the controller 29C controls driving of the motors 50a and 50b in response to the operation of the composite input unit 24 so that the distal-end working unit 12 operates. It is to be noted that, when the controller 29C carries out counting of the number of times of actual use of the working unit 16, it may apply the time rule which will be later explained.

On the other hand, if the controller 29C decides that the working unit 16 is unusable, it determines that an instruction from the composite input unit 24 is an invalid instruction. Therefore, even if an operator operates the composite input unit 24, the motors 50a and 50b are not driven and the distal-end working unit 12 does not operate.

In this manner, in the manipulator system 10c according to the third configuration example, since use history data is collected by and updated in the use history management unit 47 through the memory key 41, the latest use history data is stored into the use history management unit 47. On the other hand, in order for the controller 29 to use the working unit 16, it is necessary to connect to the controller 29 the memory key 41 which stores the use history data copied from the use history management unit 47. Therefore, the controller 29 uses the latest use history data which the use history management unit 47 has. Consequently, where a plurality of controllers 29 are provided in one medical facility, collection, updating and storage of the number of times of actual use can be carried out with certainty and the number of times of actual use can be counted appropriately.

Also with the manipulator system 10c according to the third configuration example, a term of validity (expiration date) may be set for the use history data stored in the memory key 41, similarly as in the manipulator system 10b of the second configuration example. By setting a term of validity for the use history data stored in each memory key 41 in this manner, even if a plurality of such memory keys 41 are available, the error of the number of times of actual use can be reduced.

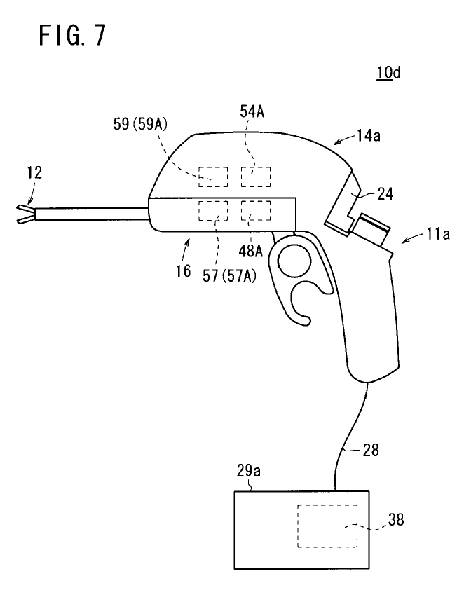

FIG. 7 shows a general configuration of a manipulator system 10d according to a fourth configuration example. Referring to FIG. 7, the manipulator system 10d includes at least one manipulator 11a and a controller 29a which can be connected to the manipulator 11a through a cable 28. The manipulator system 10d is suitable for use where a storage device 57 which may be a non-volatile storage medium of contacting or contactless read/write capability can be provided on a working unit 16a.

The manipulator 11a additionally has the storage device 57 and a reader-writer 59, as compared with the manipulator 11 shown in FIGS. 1 to 3. The storage device 57 is provided on the working unit 16a. In particular, the working unit 16a is configured by adding the storage device 57 to the working unit 16 shown in FIGS. 1 and 2. The storage device 57 in FIG. 7 is an IC tag 57A which allows readout of information stored therein and writing of information through radio communication. It is to be noted that the storage device 57 is not limited to the IC tag 57A but may be a different type of non-volatile storage medium such as one which allows contacting readout and writing.

The storage device 57 stores at least use history data of the working unit 16. Further, the storage device 57 may store information such as unique identification information, a forceps type, a working range, an operation speed, a control parameter, individual error information of the working unit 16 and so forth. Data, other than use history data, which does not need to be updated may be recorded on a barcode 48A or a QR code. Alternatively, even the barcode 48A need not be used if the storage device 57 also stores unique identification information therein.

It is to be noted that, if the storage device 57 stores only the use history data which needs to be updated, error recognition, malfunction, disabled readout and so forth due to inadvertent rewriting caused by electrical disturbances or the like can be avoided.

The reader-writer 59 provided on an operating unit 14a is capable of carrying out contacting or non-contacting readout and writing of data from and into the storage device 57. Other than additionally having the reader-writer 59, the operating unit 14a is similar to the operating unit 14 shown in FIGS. 1 and 2. Since the storage device 57 shown in FIG. 7 is the IC tag 57A, the reader-writer 59 shown in FIG. 7 is a transmitter-receiver 59A capable of carrying out non-contacting readout and writing of data from and into the IC tag 57A utilizing electromagnetic waves. A controller 29a is similar to the controller 29 shown in FIG. 1 other than having additional functions for controlling the reader-writer 59 and for executing an information process for the storage device 57.

In the manipulator system 10d in an operating condition with power being supplied thereto, when the operating unit 14a is connected to the controller 29 and a working unit 16a is attached to the operating unit 14a, the controller 29a recognizes the attachment of the working unit 16a and then controls the camera 54A so that unique identification information is acquired from the barcode 48A. The controller 29a further controls the reader-writer 59 so that unique identification information is also acquired from the storage device 57.

Then, the camera 54A acquires and analyzes the unique identification information from the barcode 48A and additionally the reader-writer 59 acquires and analyzes the unique identification information and the use history data from the storage device 57. Then, two results of the analysis, one by the camera 54A and the other by the reader-writer 59, are transferred to the controller 29a.

The controller 29a collates the unique identification information acquired from the barcode 48A and the unique identification information acquired from the storage device 57 with each other to determine whether or not they coincide with each other. At this time, if both sets of the unique identification information do not coincide with each other, it is decided that the manipulator system 10d is unusable.

On the other hand, if it is determined as a result of the collation that the unique identification information acquired from the barcode 48A and the unique identification information acquired from the storage device 57 coincide with each other, then the controller 29a refers to the use history data read out from the storage device 57. As a result, if the number of times of actual use of the working unit 16a is equal to or smaller than the use limit time number, it is decided that the working unit 16a is usable. However, if the number of times of actual use of the working unit 16a exceeds the use limit time number, it is decided that the working unit 16a is unusable.

If it is decided that the working unit 16a is usable, the controller 29a counts up the number of times of actual use of the working unit 16a and updates the use history data. Then, if the composite input unit 24 of the manipulator 11a is operated and the working unit 16a attached thereto is determined to be usable, the controller 29a carries out driving control of the motors 50a and 50b in response to the operation of the composite input unit 24 so that the distal-end working unit 12 operates. It is to be noted that the controller 29a may apply a time rule, which will be later explained, when the number of times of actual use of the working unit 16 is counted.

On the other hand, if it is decided that the working unit 16a is unusable, the controller 29a determines an instruction from the composite input unit 24 as an invalid instruction. Therefore, even if the operator operates the composite input unit 24, the motors 50a and 50b are not driven and the distal-end working unit 12 does not operate.

In this manner, in the manipulator system 10d according to the fourth configuration example, since the unique identification information and the use history data are stored in the storage device 57, the latest use history data can be retained within the working unit 16a itself. Therefore, where a plurality of controllers 29a are installed in one medical facility, one of the controllers 29a need not be used as a master controller or a special computer need not be used as a use history management unit. Further, collection, updating and storage of the use history data can be carried out easily and with certainty.

In the manipulator system 10d according to the fourth configuration example, the unique identification information acquired from the barcode 48A and the unique identification information acquired from the storage device 57 are collated with each other to decide whether or not they coincide with each other. Then, if both sets of the unique identification information do not coincide with each other, an instruction from the composite input unit 24 is considered as an invalid instruction. Therefore, if the barcode 48A or the storage device 57 is illegally altered, the working unit 16a is compulsorily placed into a disabled use state. Consequently, the effect of alterations to improperly avoid the limitation on the number of times of actual use can be nullified.

In the controller 29 described above, when the number of times of actual use of the working unit 16 is counted, the number of times of actual use may be counted by defining one use case based on a predetermined time rule hereinafter described. Here, “one case” or “one use case” in the present specification means one unit of surgical operation in which therapeutic manipulation is carried out with the manipulator 11, that is, one time of medical operation.

In particular, the controller 29 counts the number of times of actual use of the working unit 16 for each case and determines that if the number of times of actual use of the working unit 16 exceeds the use limit time number or preset number of times, an instruction from the composite input unit 24, which is an operation input unit, is an invalid instruction. In particular, if the number of times of actual use of the working unit 16 exceeds the use limit time number, the controller 29 does not carry out control for driving the motors 50a and 50b even if the composite input unit 24 is operated.

The time rule is a rule for defining one use case. When the working unit 16 is used for a medical operation carried out for an excessively long period of time, if this lengthy use is regarded as a single time of use, the durability of the working unit 16 can be compromised. Therefore, according to the time rule, a maximum time period such as five hours per use case, for example, is considered as a reference time period for counting up the use data and the reference time period is set in the controller 29. Then, the controller 29 counts up the number of times of actual use of the working unit 16 based on the set reference time period.

More particularly, according to the time rule, when a working unit 16 is initially attached to the operating unit 14 and the controller 29 recognizes the unique identification information where no use case has started yet, an initial case then starts and the number of times of actual use of the working unit 16 is counted up. Then, if the working unit 16 remains attached for a period exceeding the preset time after the unique identification information is recognized, the case is considered to be over and a new case starts.

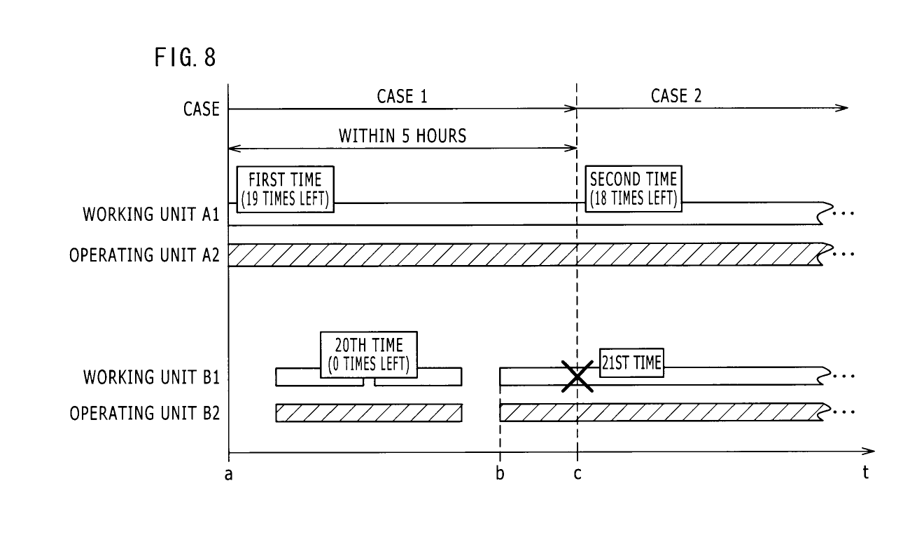

Referring to FIG. 8, the horizontal axis indicates time and represents a connection status between the operating units 14 (denoted by A2 and B2) and the controller 29 and an attachment status of the working units 16 (denoted by A1 and B1) onto the operating units A2 and B2, as indicated by presence or absence of a bar extending in the direction of the horizontal axis. In particular, a blank bar indicates a period within which the working unit A1 (B1) is attached to the operating unit A2 (B2), and a hatched bar indicates a period within which the operating unit A2 (B2) is connected to the controller 29.

Here, an example of counting of the number of times of actual use under the time rule will be described, taking a case wherein the preset time is set to five hours and the use limit time number or preset time number is set to twenty as an example. As seen in FIG. 8, for example, when the operating unit A2 is connected to the controller 29 and the working unit A1 is attached to the operating unit A2 at time a, the unique identification information of the working unit A1 is recognized by the controller 29. If only the operating unit A2 is connected to the controller 29 before time a and then the working unit A1 is attached to the operating unit A2 at time a, the unique identification information of the working unit A1 is recognized similarly as in the case described above. Then, the controller 29 determines that use case 1 (the first surgical operation) has started and counts up the number of times of actual use of the working unit A1. The controller 29 also starts counting down of a first rule utilizing a timer function. At this time, it is assumed in this particular example that the number of times of actual use of the working unit A1 is counted up to “one time” (19 times more uses available).

Further, if the operating unit B2 is also connected to the controller 29 and the working unit B1 is attached to the operating unit B2 after time a, the unique identification information of the working unit B1 is recognized by the controller 29 and the number of times of actual use of the working unit B1 is counted up. At this time, it is assumed in this example that the number of times of actual use of the working unit B1 is counted up to “20 times” (no more use available).

If the operating unit B2 and the working unit B1 are separated a little before time b and then the operating unit B2 and the working unit B1 are re-connected at time b, the number of times of actual use of the working unit B1 is not further counted up since the number of times of actual use of the working unit B1 has been already counted within the period of case 1. Since the use time according to the first rule reaches five hours, that is, the preset time, at time c, the controller 29 determines that use case 2 (the next case), has started and counts up the number of times of actual use of the working units A1 and B1. In this instance, since the number of times of actual use of the working unit B1 now exceeds 20 times, the use limit which is the times number, the working unit B1 becomes disabled from use. In other words, if the composite input unit 24 in the operating unit B2 is operated after time c, the controller 29 determines an instruction from the composite input unit 24 as an invalid instruction and does not carry out driving control for the motors 50a and 50b.

In this manner, in the manipulator system 10 according to the present invention, whether a changeover of one use case to another use case occurs is decided based on both a situation of attaching/detaching of a working unit 16 and a period of use of the working unit 16. Therefore, if predetermined conditions are set with regard to the situation of attaching/detaching of a working unit 16 and a period of use of the working unit 16, it is possible to define one use case appropriately, and as a result, it is possible to count the number of times of actual use of the working unit 16 appropriately. In other words, by setting the first preset time period to correspond to a maximum period which can be regarded as one use case or one medical operation, any number of times of use of the working unit 16 within the first preset time period is regarded as a single use.

Further, with the configuration described above, every time the use time period of the working unit 16 exceeds the preset time period or reference time period, it is determined that the use case has changed over to the next use case. Therefore, if the medical operation time period is considerably long, a single use of the working unit 16 for a long time will be counted as if a plural number of times of use are carried out. Accordingly, an appropriate timing for prohibiting further use of the working unit 16 based on the number of times of actual use can be reasonably controlled.

Further, if the number of times of actual use of the working unit 16 exceeds its use limit time number or preset time number, an instruction from the operation inputting section is determined as an invalid instruction. Therefore, even if the operator operates the composite input unit 24, the driving source is not driven, and consequently, the distal-end working unit 12 including the end effector 19 does not operate. Consequently, the working unit 16, whose number of times of actual use reaches its use limit time number, can be compulsorily made unusable.

The timing of a start of a use case need not necessarily be determined in the way as descried hereinabove. The time at which data of the memory key 41 is updated, the time at which power supply is made available to the controller 29, the time at which the operating unit 14 is connected, the time at which a working unit 16 is connected and an operation is started or like time may be set as the timing of a start of a use case.

Further, such a standardized (common) use case start timing as described above need not necessarily be used for plural manipulators, but a start timing of one use case may be set for each working unit 16 with reference to the timing at which the operating unit 14 is connected to the controller 29, the timing at which the working unit 16 is attached to the operating unit 16 and an operation is started or a like timing. If the start timing of one use case is set in this manner, it is possible to prevent excessive counting regarding a working unit 16 which is used only in the latter half of a use case which continues for such a long period of time as to exceed the set time.

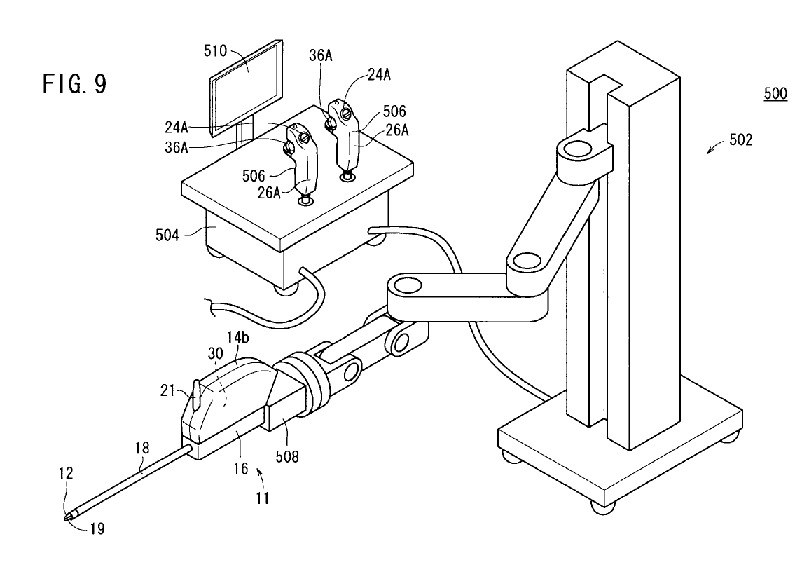

The preferred embodiments described above can be also applied, for example, to such a robot system 500 for medical operation as shown in FIG. 9.

Referring to FIG. 9, the robot system 500 for medical operation includes a robot arm 502 of the articulated type, and a console 504 for controlling the robot arm 502. A mechanism same as the manipulator 11 described above is provided at the distal end of the robot arm 502. In place of the operating unit 14, a base unit 14b which accommodates a driving unit 30 therein is secured to a distal end portion 508 of the robot arm 502, and a working unit 16 on which a distal-end working unit 12 is provided is removably attached to the base unit 14b.

The robot arm 502 may be any mechanism to move the working unit 16 in various directions, and need not be a robot arm of the installation type but be a robot arm of the autonomous travel type. If the robot arm 502 has six or more independent joints such as a rotational shaft, a slide shaft or the like, the position and the direction of the working unit 16 can be arbitrarily controlled. The base unit 14b is integrated with the distal end portion 508 of the robot arm 502.

The console 504 includes two joysticks 506 as operation instruction units and a monitor 510. The console 504 can adopt a configuration of the table type, control board type or the like. The robot arm 502 may be configured so as to operate under control of the console 504 to carry out an automatic operation in accordance with a program, an operation through the joysticks 506 provided on the console 504, and composite operation of such operations. The console 504 includes the functions of the controller 29 described above.

It is possible to operate two robot arms 502 independently from each other by using the two joysticks 506 through only one robot arm 502 is shown in FIG. 9. The joysticks 506 are provided at positions at which they can be operated readily by both hands. The joysticks 506 can be moved upward and downward, leftward and right, twisted and tilted movements and can move the robot arm 502 in response to such movements. The joysticks 506 may otherwise be master arms.

Each of the joysticks 506 includes a grip handle 26A, a trigger lever 36A operated to push and pull, and a composite operating unit 24A operated to pivot and tilt. The trigger lever 36A is similar to the trigger lever 36 described above, and by operating the trigger lever 36A, a motor (not shown), which is an actuator which operates in an interlocking relationship with a manually operated input unit, is driven to operate an end effector 300 to open or close.

The composite operating unit 24A is similar the composite input unit 24 described above, and by operating the composite operating unit 24A, the driving unit 30 is controlled by the console 504 in response to the operation so that rolling movement, tilting movement or composite movement of the distal-end working unit 12 is carried out.

Communication means between the robot arm 502 and the console 504 may be wire communication, wireless communication, communication by a network or a combination of them. On the monitor 510, an image and so forth picked up by a flexible mirror such as a fiber scope is displayed.

In summary, with the medical manipulator system of the present invention, the number of times of actual use of a working unit can be counted appropriately, and if the number of times of actual use reaches a preset number of times, then the working unit can be compulsorily disabled from use.

In the medical manipulator system, if the number of times of actual use of the working unit exceeds the preset number of times, then the controller decides that the working unit is unusable and determines an instruction from the operation input unit to be an invalid instruction. Therefore, even if an operator operates the operation input unit, the driving source does not operate, and as a result, the distal-end working unit does not operate. Accordingly, when the number of times of actual use reaches the preset number of times, the working unit can be compulsorily disabled from use.

The ID retaining unit may be an indication unit that indicates an image pattern corresponding to the unique identification information, the ID detection unit being an image pickup unit that picks up an image of the indication unit, the controller having the use history retaining unit built therein to carry out collection, updating and storage of the use history data.

The medical manipulator system of the configuration described above is suitable for use in the case where a single controller is installed in one medical facility.

The ID retaining unit may be an indication unit that indicates an image pattern corresponding to the unique identification information, the ID detection unit being an image pickup unit that picks up an image of the indication unit, a plurality of such controllers being provided, the manipulator being capable of being connected to the plural controllers, one of the plural controllers being a master controller for carrying out collection, updating and storage of the use history data which the remaining controller or each of the remaining controllers is a slave controller or controllers, a memory key which functions as the use history retaining unit being capable of being connected to the master controller and the slave controller, the master controller copying the latest use history data into the memory key which is connected thereto, the slave controller being operable to read out the use history data copied by the master controller from the memory key which is connected thereto, refer to the unique identification information of the working unit of the manipulator which is connected thereto and the use history data, and then update, in the case where the number of times of actual use of the working unit is equal to or less than the preset number of times, the use history data of the memory key but determine, in the case where the number of times of actual use of the working unit exceeds the preset number of times, the instruction from the operating input unit as an invalid instruction.

The medical manipulator system of the configuration described above is suitable for use in the case where a plurality of controllers are installed in one medical facility. In particular, since the use history data is collected and updated by the master controller through the memory key, the latest use history data is stored in the master controller. On the other hand, in order to use the working unit on the slave controller side, it is necessary to connect the memory key, in which the use history data copied from the master controller is stored, to the slave controller, the slave controller uses the latest use history data which the master controller has. Consequently, even in the case where a plurality of controllers are provided in one medical facility, collection, updating and storage of the number of times of actual use can be carried out with certainty, and the number of times of actual use can be counted appropriately.

In this instance, the medical manipulator system may be configured such that, if the memory key is connected to the slave controller after lapse of a predetermined term of validity after the use history data is copied from the master controller into the memory key, then the slave controller determines the use history data as invalid data, thereby to determine the instruction from the operating input unit as an invalid instruction.

With the medical manipulator system of the configuration just described, since a predetermined term of validity is set to the memory key, even where a plurality of memory keys are available, the error in number of times of actual use can be reduced.

The medical manipulator system may further include a use history management unit that carries out collection, updating and storage of the use history data, the ID retaining unit being indication unit that retains the unique identification information as image information, the ID detection unit being an image pickup unit that picks up an image of the indication unit, a plurality of such controllers being provided, the manipulator being capable of being connected to the plural controllers, a memory key which functions as the use history retaining unit being capable of being connected to the use history management unit and the controller, the use history management unit copying the latest use history data into the memory key which is connected thereto, each of the controllers being operable to read out the use history data from the memory key which is connected thereto, refer to the unique identification information of the working unit of the manipulator which is connected thereto and the use history data, and then update, in the case where the number of times of actual use of the working unit is equal to or less than the preset number of times, the use history data of the memory key but determine that the instruction from the operating input unit to be an invalid instruction in the case where the number of times of actual use of the working unit exceeds the preset number of times.

The medical manipulator system of the configuration described above is suitable for use in the case where a plurality of controllers are installed in one medical facility. In particular, since the use history data is collected into the use history management unit through the memory key and updated in the use history management unit, the latest use history data is stored in the use history management unit. On the other hand, in order to use the working unit on the controller side, it is necessary to connect the memory key, in which the use history data copied from the use history management unit is stored, to the controller, the controller uses the latest use history data which the use history management unit has. Consequently, even where a plurality of controllers are provided in one medical facility, collection, updating and storage of the number of times of actual use can be carried out with certainty, and the number of times of actual use can be counted appropriately.

In this instance, the medical manipulator system may be configured such that, if the memory key is connected to any of the controllers after lapse of a predetermined term of validity after the use history data is copied from the use history management unit into the memory key, then the controller determines the use history data to be invalid data.

With the medical manipulator system of the configuration just described, since a predetermined term of validity is set to the memory key, even where a plurality of memory keys are available, the error in the number of times of actual use can be reduced.

The working unit may include a storage device which can store at least the use history data and allows contacting or non-contacting readout and writing, the operating unit including a reader-writer capable of carrying out contacting or non-contacting readout and writing of data from and into the storage device, the reader-writer reading out the use history data from the storage device and transmitting the read out data to the controller under the control of the controller, the controller being operable to refer to the use history data read out from the storage device, and update, in the case where the number of times of actual use of the working unit is equal to or less than the preset number of times, the use history data of the storage device but determine, where the number of times of actual use of the working unit exceeds the preset number of times, the instruction from the operating input unit as an invalid instruction.

The medical manipulator system of the configuration described above is suitable for use in the case where a storage device which allows contacting or non-contacting readout and writing can be installed in the working unit. In particular, since it is possible to store at least the use history data in the storage device, the working unit itself can retain the latest use history data. Therefore, even where a plurality of controllers are provided in one medical facility, collection, updating and storage of the use history data can be carried out simply, conveniently and with certainty without the necessity to use one of the controllers as a master controller or use a separate computer as the use history management unit.

In this instance, the ID retaining unit may be an indication unit for indicating an image pattern corresponding to the unique identification information, the ID detection unit being image pickup means for picking up an image of the indication unit. Further, in this instance, the medical manipulator system may be configured such that the unique identification information is recorded in or on the storage device, and the controller picks up an image of the indication unit by means of the image pickup unit, acquires unique identification information of the manipulator which is connected thereto, collates the unique identification information acquired from the indication unit and the unique identification information acquired from the storage device with each other to decide whether or not both sets of the unique identification information coincide with each other and determine, if both sets of the unique identification information do not coincide with each other, the instruction from the operating input unit as an invalid instruction.

With the medical manipulator system of the configuration just described, the unique identification information acquired from the indication unit and the unique identification information acquired from the storage device are collated with each other to decide whether or not they coincide with each other. Then, if both sets of the unique identification information do not coincide with each other, the instruction from the operation input unit is determined as an invalid instruction. Therefore, if the indication unit or the storage device is illegally altered, then the working unit is compulsorily placed into a disabled use state. Consequently, the effect of alterations to improperly avoid the limitation on the number of times of actual use can be nullified.

The controller may decide based on a situation of attaching/detaching of the working unit and a period of time of actual use of the working unit whether or not a use case is changed over, and then apply a rule that, if it is decided that a use case is changed over, the number of times of actual use of the working unit is counted up and, if the number of times of actual use of the working unit exceeds the preset number of times, the instruction from the operating input unit is determined as an invalid instruction.

In the medical manipulator system of the configuration described above, since whether or not a use case is changed over is decided based on a situation of attaching/detaching of the working unit and a period of time of actual use of the working unit, if predetermined conditions are set with regard to the situation of attaching/detaching of the working unit and the period of time of actual use of the working unit, then it is possible to define one use case appropriately. As a result, it is possible to count the number of times of actual use of the working unit appropriately. Further, if the number of times of actual use of the working unit exceeds the preset number of times, that is, a use limit time number, then the instruction from the operation input unit is determined as an invalid instruction. Therefore, even if the user operates the operation input unit, the driving source does not operate, and accordingly, the distal-end working unit including the end effector does not operate. Consequently, when the number of times of actual use reaches the preset number of times, the working unit can be compulsorily disabled from use.

In this instance, the controller may decide, when the working unit is attached to the operating unit and the unique identification information is recognized in a state wherein the rule is not applied, that a new use case is started, and decide that, if the working unit continues to be attached for more than a preset period of time after the unique identification information is recognized, then the use case is changed over every time the preset period of time elapses.

In the medical manipulator system of the configuration described above, if a first preset period of time is set so as to correspond to a maximum period of time which is to be regarded as one use case or one medical operation, then use within the first present period of time is regarded as one use, and the number of times of actual use is counted. Further, since it is decided that the use case is changed over every time the period of time of actual use of the working unit exceeds the first preset period of time, in the case of a lengthy use case, it is considered that a plural number of times of actual use are carried out. Accordingly, normalization of the timing for use limitation based on the number of times of actual use can be anticipated.

While preferred embodiments of the present invention have been described using specific terms, such description is for illustrative purposes only, and it is to be understood that changes and variations may be made without departing from the spirit or scope of the following claims.

What is claimed is:

1. A medical manipulator system comprising:
a manipulator including an operating unit and a working unit removably attachable thereto, the working unit including, at a distal end thereof, an end effector that carries out motions for medical treatment, the operating unit including an input unit operable by an operator and a driving source that drives the end effector, the working unit further including an ID retaining unit configured to retain identification information unique to the working unit, and the operating unit further including an ID detection unit configured to detect the identification information retained by the ID retaining unit;
a controller connectable to the operating unit and configured to control the driving source in response to an operation by the operator of the input unit; and
a use history retaining unit configured to retain use history data of the working unit,
wherein the controller is configured to refer to the use history data of the working unit attached to the operating unit and determine that the operation by the operator of the input unit is invalid if the use history data indicates that the working unit has been used more times than a preset number of times.

2. The medical manipulator system according to claim 1, wherein:
the ID retaining unit includes an image pattern corresponding to the identification information of the working unit and the ID detection unit is configured to pick up the image pattern; and
the controller includes the use history retaining unit therein and is configured to carry out collection, updating and storage of the use history data retained in the use history retaining unit.

3. The medical manipulator system according to claim 1, further comprising at least two of the controllers, one of which is a master controller that carries out collection, updating and storage of the use history data retained in the use history retaining unit, and the other of which is a slave controller, wherein:
the ID retaining unit includes an image pattern corresponding to the identification information of the working unit and the ID detection unit is configured to pick up the image pattern;
the use history retaining unit is a removable memory selectively connectable to the master controller and to the slave controller;
the master controller is configured to copy the latest use history data into the removable memory when the removable memory is connected thereto; and
the slave controller is configured to refer to the use history data in the removable memory which is connected thereto, further refer to the identification information of the working unit attached to the operating unit which is connected to the slave controller, determine that the operation by the operator of the input unit is invalid if the use history data indicates that the working unit has been used more times than the preset number of times, but otherwise update the use history data in the removable memory by incrementing a use time of the working unit.

4. The medical manipulator system according to claim 3, wherein, when the removable memory is connected to the slave controller after a lapse of a predetermined term of validity after the latest use history data is copied from the master controller into the removable memory, the slave controller is configured to determine that the use history data in the removable memory is invalid and that the operation by the operator of the input unit is invalid.

5. The medical manipulator system according to claim 1, further comprising:
at least two of the controllers; and
a use history management unit configured to carry out collection, updating and storage of the use history data retained in the use history retaining unit, wherein:
the ID retaining unit retains the identification information as image information;
the ID detection unit picks up the image information;
the use history retaining unit is a removable memory selectively connectable to the use history management unit and to the controllers;
the use history management unit copies the latest use history data into the removable memory when the removable memory is connected thereto; and
each of the controllers refers to the use history data in the removable memory which is connected thereto, further refers to the identification information of the working unit attached to the operating unit which is connected to the controller, determines that the operation by the operator of the input unit is invalid if the use history data indicates that the working unit has been used more times than the preset number of times, but otherwise updates the use history data in the removable memory by incrementing a use time of the working unit.

6. The medical manipulator system according to claim 5, wherein the controller determines that the use history data in the removable memory is invalid if the removable memory is connected to any of the controllers after a lapse of a predetermined term of validity after the latest use history data is copied from the use history management unit into the removable memory.

7. The medical manipulator system according to claim 1, wherein:
the working unit includes a storage device configured to store the use history data;
the operating unit includes a reader-writer configured to read out and write data from and into the storage device, the reader-writer reading out the use history data from the storage device and transmitting the read out data to the controller under the control of the controller;
the controller is configured to refer to the use history data read out from the storage device, determine that the operation by the operator of the input unit is invalid if the use history data indicates that the working unit has been used more times than the preset number of times but otherwise, and update the use history data in the storage device by incrementing a use time of the working unit.

8. The medical manipulator system according to claim 7, wherein the ID retaining unit includes an image pattern corresponding to the identification information of the working unit and the ID detection unit is configured to pick up the image pattern.

9. The medical manipulator system according to claim 8, wherein backup identification information is additionally recorded in the storage device and
the controller is configured to determine whether the identification information detected by the ID detection unit is the same as the backup identification information stored in the storage device and further to determine that the operation by the operator of the input unit is invalid if the identification information and the backup identification information do not match.

10. The medical manipulator system according to claim 1, wherein the controller is configured to set a surgical period having a predetermined duration and update the use history data retained in the use history retaining unit by incrementing a use time of the working unit if the working unit continues to be attached to the operating unit in a usable condition after the surgical period is over.

11. The medical manipulator system according to claim 10, wherein the controller is configured to start an initial surgical period when the working unit becomes attached to the operating unit in a usable condition and the identification information is recognized where no surgical period has started yet, and to update the use history data retained in the use history retaining unit by incrementing a use time of the working unit if the working unit continues to be attached to the operating unit in a usable condition every time the surgical period changes over to a next surgical period.

12. The medical manipulator system according to claim 1, wherein the controller is configured to set a surgical period having a predetermined duration and update the use history data retained in the use history retaining unit by incrementing a use time of the working unit when the working unit becomes attached to the operating unit for the first time within the surgical period, but not to update the use history data when the working unit is detached and attached again within the same surgical period.

13. A medical manipulator system comprising:
a manipulator including an operating unit and a working unit removably attachable thereto, the working unit including, at a distal end thereof, an end effector that carries out motions for medical treatment, the operating unit including a driving source that drives the end effector, the working unit further including an ID retaining unit configured to retain identification information unique to the working unit, and the operating unit further including an ID detection unit configured to detect the identification information retained by the ID retaining unit;
a controller console that includes an input unit operable by an operator and configured to control the driving source in response to an operation by the operator of the input unit; and
a use history retaining unit configured to retain use history data of the working unit;
wherein the controller is configured to refer to the use history data of the working unit attached to the operating unit and determine that the operation by the operator of the input unit is invalid if the use history data indicates that the working unit has been used more times than a preset number of times.

14. A medical manipulator system comprising:
a manipulator including operating means and working means removably attachable thereto, the working means including, at a distal end thereof, end effector means for carrying out motions for medical treatment, the operating means including input means, operable by an operator, for sending an instruction and driving means for driving the end effector means, the working means further including ID retaining means for retaining identification information unique to the working means, and the operating means further including ID detection means for detecting the identification information retained by the ID retaining means;
controlling means, connectable to the operating means, for controlling the driving means in response to the instruction from the input means; and
use history retaining means for retaining use history data of the working means;
wherein the controller means refers to the use history data of the working means attached to the operating means and determines that the instruction from the input means is invalid if the use history data indicates that the working means has been used more times than a preset number of times.
